(19) United States
(12) Patent Application Publication
(10) Pub. No.: US 2026/0236196 A1
(43) Pub. Date: Aug. 13, 2026

(54) STORAGE MEDIUM STORING PROGRAM, INFORMATION PROCESSING APPARATUS, AND SYSTEM

(71) Applicant: BROTHER KOGYO KABUSHIKI KAISHA, Nagoya (JP)

(72) Inventor: Ryoji BAN, Kiyosu (JP)

(21) Appl. No.: 19/633,288

(22) Filed: Mar. 30, 2026

Related U.S. Application Data
(63) Continuation of application No. PCT/JP2024/034634, filed on Sep. 27, 2024.

(30) Foreign Application Priority Data
Oct. 20, 2023 (JP) 2023-180848

(51) Int. Cl. G06F 3/12

(52) U.S. Cl. CPC G06F 3/1204; G06F 3/1224; G06F 3/1253; G06F 3/1267; G06F 3/1288

(57) ABSTRACT

An information processing apparatus is configured to communicate with a first server via a communication interface. A set of program instructions, when executed by a controller, causes the information processing apparatus to perform: acquiring printer information from a printer connected to the information processing apparatus; in response to receiving an access instruction to the first server, controlling a display to display a particular screen provided from the first server, and after displaying the particular screen, receiving a creation instruction of creating a user account; and in response to receiving the creation instruction, controlling the display to display an account creation screen for receiving input of registration information used for creating the user account. The account creation screen includes an input field for receiving printer information. The input field is filled with the acquired printer information as an initial value of the printer information.

### REFERENCE TO RELATED APPLICATIONS

This is a Continuation Application of International Application No. PCT/JP2024/034634 filed on Sep. 27, 2024, which claims priority from Japanese Patent Application No. 2023-180848 filed on Oct. 20, 2023. The entire content of each of the prior applications is incorporated herein by reference.

### BACKGROUND ART

In a system, a server for storing various content data is prepared on the Internet, and a user downloads content data through the Internet.

### SUMMARY

For example, in a point management system, when photo data is uploaded from a PC of a user A to a WWW server, and the photo data is purchased and downloaded from the WWW server by a PC of a user B, points according to the purchase amount are added to the user B as the purchaser, and points according to the data size of the photo data are also added to the user A as the posting user when the photo data is uploaded or downloaded.

In recent years, a system for sharing label data used for printing labels in a label printer has been studied, and in such a system, a user account for using the system is registered. When the user account is registered, the user is requested to enter various information, but if many input items are to be entered, it may be troublesome for the user.

According to one aspect, this specification discloses a non-transitory computer-readable storage medium storing a set of program instructions for an information processing apparatus including a controller and a communication interface. The information processing apparatus configured to communicate with a first server via the communication interface. The set of program instructions, when executed by the controller, causes the information processing apparatus to perform acquiring printer information from a printer connected to the information processing apparatus. Thus, the printer information is acquired from the printer. The set of program instructions, when executed by the controller, causes the information processing apparatus to perform, in response to receiving an access instruction to the first server, controlling a display to display a particular screen provided from the first server, and after displaying the particular screen, receiving a creation instruction of creating a user account. Thus, the creation instruction of creating the user account is received via the particular screen. The set of program instructions, when executed by the controller, causes the information processing apparatus to perform, in response to receiving the creation instruction, controlling the display to display an account creation screen for receiving input of registration information used for creating the user account. Thus, the registration information used for creating the user account is received via the account creation screen. The account creation screen includes an input field for receiving printer information. The input field of the account creation screen is filled with the acquired printer information as an initial value of the printer information. Thus, the printer information is automatically entered into the input field of the account creation screen as the initial value.

According to the above program, the printer information is acquired from the printer in advance, and when a new user account is created, the program enters the printer information into the input field of the printer information of the account creation screen, thereby eliminating the user's operation of entering the printer information. This reduces the user's trouble of creating the user account.

A control method for realizing the functions of the program, an information processing apparatus and a system configured to execute the instructions of the program, and a computer-readable storage medium storing the computer program are also novel and useful.

The technique disclosed in the present specification facilitates the user registering a user account in a system that requests registration of the user account.

### BRIEF DESCRIPTION OF DRAWINGS

FIG. 1 is a schematic diagram of a system.

FIG. 2 illustrates an example of an account database.

FIG. 3 illustrates an example of a user database.

FIG. 4 illustrates an example of a label database.

FIG. 5 is a sequence diagram showing a process from the start of a user registration procedure to displaying of a login screen.

FIGS. 6A, 6B, 6C and 6D illustrate an example of a screen transition from the start of the user registration procedure to the login screen.

FIG. 7A is a sequence diagram showing a process from displaying the login screen in the user registration procedure to registering a user account.

FIG. 7B is a sequence diagram showing the user registration procedure from the registration of a user account to the end of the registration.

FIG. 8A illustrates an example of a new account registration screen.

FIG. 8B illustrates an entirety of the new account registration screen.

FIG. 8C illustrates an example of a user information input screen.

FIGS. 9A, 9B and 9C illustrate an example of a screen transition of a procedure for posting label data.

FIG. 10 is a sequence diagram showing a procedure for posting label data.

### DESCRIPTION

Hereinafter, an embodiment embodying a program for registering a user account will be described in detail with reference to the accompanying drawings. The present specification discloses a procedure for creating a user account for using a label data sharing system in which a server and a plurality of information processing apparatuses are connected via a network to share label data used for printing labels by a label printer.

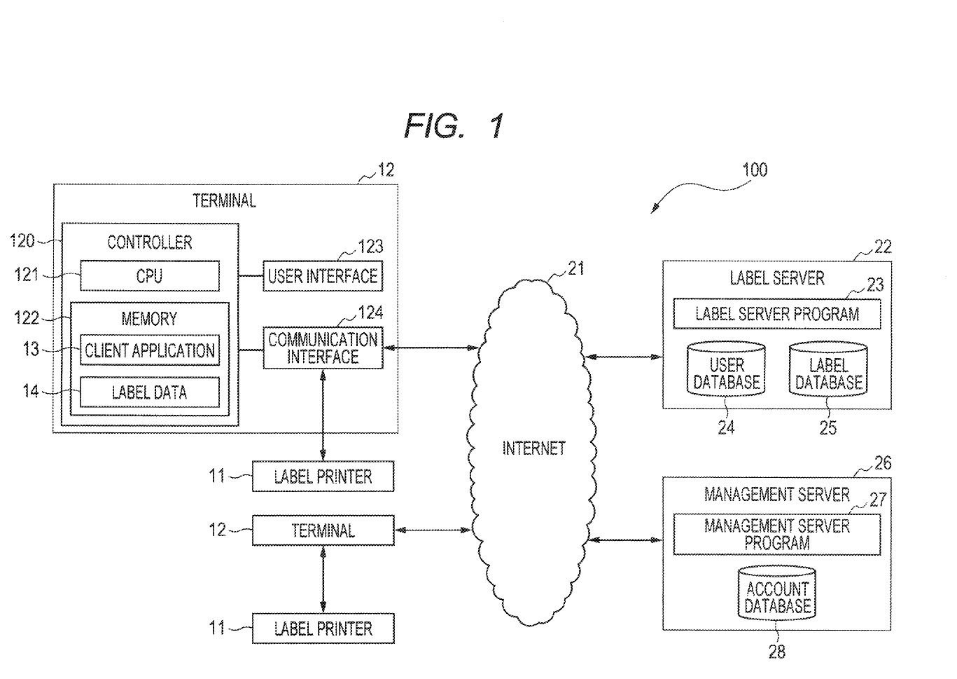

As shown in FIG. 1, a label data sharing system 100 (hereinafter, referred to as "system 100") of the present embodiment is provided by a vendor of a label printer 11. The system 100 includes a plurality of terminals 12, a label server 22, and a management server 26, which are connected to each other via Internet 21. Each terminal 12 is connectable to at least one label printer 11.

The terminal 12 is an apparatus having a communication function, a display function, and an operation reception function. The terminal 12 includes a controller 120 including a CPU 121 and a memory 122. The terminal 12 is an example of an information processing apparatus. The CPU 121 is an example of a computer (controller). The terminal 12 includes a user interface 123 and a communication interface 124, which are electrically connected to the controller 120. The controller 120 in FIG. 1 is a generic name including hardware and software used for controlling the terminal 12, and does not necessarily represent a single hardware actually existing in the terminal 12. The terminal 12 may be a portable terminal such as a smartphone or a tablet computer, or may be a personal computer.

The user interface 123 includes hardware for displaying a screen for informing the user of information and hardware for receiving an operation by the user. The user interface 123 may be a combination of a display configured to display information and a mouse, a keyboard, and so on, having an operation reception function, or may be a touch panel having the display function and the operation reception function.

The communication interface 124 includes hardware for communicating with external apparatuses such as the label printer 11, the label server 22, and the management server 26. The communication standard of the communication interface 124 is Ethernet, Wi-Fi, or USB, for example. The terminal 12 may include a plurality of communication interfaces 124 corresponding to a plurality of communication standards. The "Wi-Fi" is a registered trademark of Wi-Fi Alliance.

A client application program (hereinafter, referred to as "client application") 13 is incorporated in the memory 122 of each terminal 12. The client application 13 is an example of a program. Each terminal 12 is configured to store label data 14. The label data 14 is printed by the label printer 11 and is created by using the client application 13.

The client application 13 is an application program provided by a vendor of the label printer 11. The client application 13 has various functions such as an editing function of creating or editing the label data 14 based on a user instruction, a storing function of storing the created label data 14 in the memory 122 of the terminal 12, and a printing function of transmitting print data based on the created label data 14 to the label printer 11 to perform printing.

The client application 13 is configured to communicate with the label server 22 via the Internet 21 to use services provided by the label server 22. In this embodiment, the label server 22 provides services relating to label data, and the client application 13 has a function of uploading the label data 14 stored in the memory 122 of the terminal 12 to the label server 22, and a function of downloading label data registered (stored) in a label database 25 from the label server 22 to the terminal 12. In the present specification, uploading label data to the label server 22 may be referred to as "posting" label data.

The label printer 11 is an apparatus that includes a thermal transfer type print head, for example, and is configured to perform printing while taking out a label sheet wound in a roll. The label printer 11 is configured to print an image on the label sheet stored inside and convey the label sheet based on the label data received from the terminal 12, for example, and cause the printed portion to project to the outside of the printer. The label printer 11 is configured to communicate with the terminal 12 by wireless LAN communication such as Wi-Fi or short-range wireless communication such as Bluetooth. The label printer 11 may be configured to communicate with the terminal 12 by wired communication based on the USB standard. The "Bluetooth" is a registered trademark of Bluetooth SIG, Inc.

The management server 26 has at least a storage function and a communication function. The management server 26 is set up by the manufacturer of the label printer 11, for example. The manufacturer of the label printer 11 provides various services including the services provided by the label server 22, and the management server 26 manages a common user account used in the various services. The management server 26 includes a management server program 27.

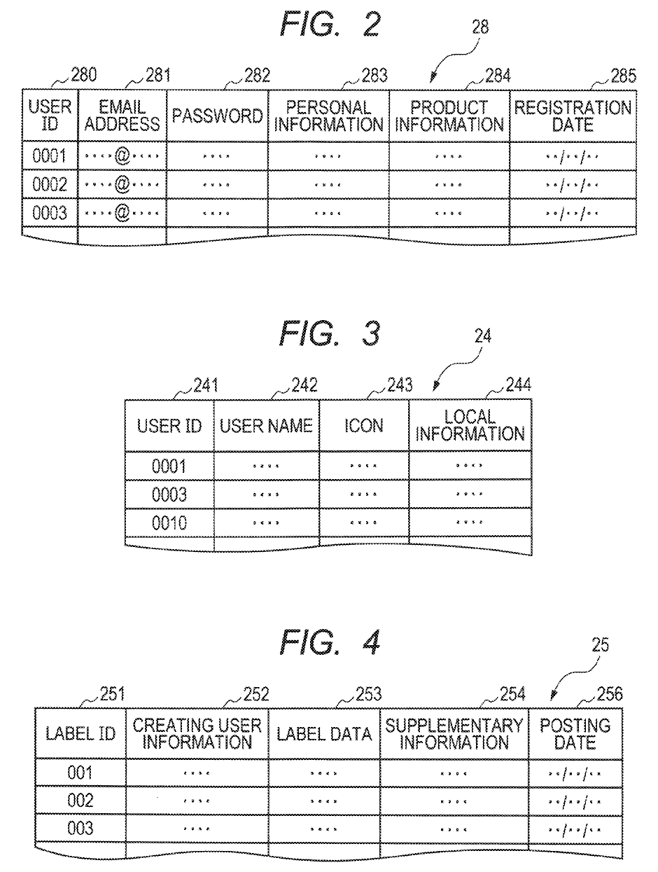

The management server 26 includes an account database 28. The account database 28 is a database for storing information on each user account. As shown in FIG. 2, a record including a user ID 280, an email address 281, a password 282, personal information 283, product information 284, and a registration date 285 is registered (stored) in the account database 28 for each user account. The user ID 280 is a serial number assigned in the order of registration for each user account, and is identification information of the user account. The email address 281 is information indicating a contact address of the user. The email address 281 may also serve as identification information of the user account. In this case, registration of a user account with the same email address is restricted. The password 282 is information used for authentication. The personal information 283 is personal information of the user, and includes, for example, a name, a date of birth, and a telephone number. The product information 284 is information indicating a printer purchased by the user, and includes, for example, a model name, a serial number of the product, a purchase date, and a store where the printer is purchased. The registration date 285 is information indicating the date and time when the user account is registered.

The label server 22 has at least a storage function and a communication function, and is a server constructed by, for example, a manufacturer of the label printer 11. The manufacturer of the label printer 11 provides a service for sharing label data by the label server 22. The label server 22 includes a label server program 23.

The label server 22 includes a user database 24 and the label database 25. The user database 24 is a database for storing user information of each user account for using the services provided by the label server 22. The label database 25 is a database in which label data are registered (stored). The label data registered in the label database 25 are not limited to the label data posted from the terminals 12, and may be, for example, label data provided by a vendor (manufacturer) of the label printer 11.

As shown in FIG. 3, the user database 24 is configured to register (store) a record including a user ID 241, a user name 242, an icon 243, and local information 244 for each user account. The user ID 241 is information for identifying a user account. The user ID 280 of the user account registered in the account database 28 of the management server 26 is written in the user ID 241. In a case where the email address also serves as identification information of the user account, the email address may be written in place of the user ID. The user name 242 is a name or nickname of a user or an organization (corporation). The icon 243 is an icon set by the user. The local information 244 is information indicating an environment to be used, and may be, for example, a language or a region.

The user database 24 is a database for managing user information about users of services provided by the label server 22. The user database 24 does not necessarily manage user information about all user accounts registered in the account database 28 of the management server 26. That is, when a user of the service provided by the label server 22 performs an operation for registering user information for the label server 22, a record corresponding to the user account of the user is registered (stored) in the user database 24.

The label server 22 uses a user account registered in the management server 26 for authentication of a user of the service, and requests an input of a user account managed by the management server 26 when registering the user of the service. The user ID of the user account registered in the account database 28 of the management server 26 is written in the record of the user account to be registered in the user database 24.

As shown in FIG. 4, the label database 25 is configured to register a record including a label ID 251, creating user information 252, label data 253, supplementary information 254, and posting date 256 for each label data. The label ID 251 is a serial number assigned to each label data in the order of registration. The creating user information 252 is information indicating a user who created the label data that is registered, and the user ID 241 of the user database 24 (the user ID 280 of the account database 28) is written in the creating user information 252. Instead of the user ID, the user name 242 of the user database 24 may be written. In the creating user information 252 of the label data created by a user other than the user having the user account, identification information indicating an administrator is written, identification information indicating the vendor having created the label data is written, or the information is left blank.

The label data 253 is data created by the client application 13. The label data stores information indicating the configuration of the label. The information indicating the configuration of the label includes, for example, the types of objects included in the label, the parameter for each object, and the arrangement of each object. The supplemental information 254 stores information that is added when the label data is uploaded to the label server 22. The posting date 256 is information indicating the date when the label data is uploaded.

The user of the terminal 12 accesses the label server 22 through the client application 13 to use the services provided by the label server 22. The label server 22 registers label data transmitted from the terminal 12, that is, posted label data, in the label database 25, and the label server 22 allows the terminal 12 to download label data registered (stored) in the label database 25, which are part of the services provided by the label server 22.

For example, a user X of the terminal 12 creates label data Y by the client application 13 and posts the label data Y to the label server 22. A user Z of the other terminal 12 downloads the label data Y from the label server 22 by the client application 13. This allows the user Z of the other terminal 12 to use the label data Y created by the user X, and the label data Y is shared via the label server 22.

The services provided by the label server 22 include services that request user authentication using a user account registered in advance, that is, services that request login. Among the services provided by the label server 22, registration of posted label data and download of registered label data are also services requesting login.

Next, a procedure for creating a new user account in the terminal 12 of the system 100 and registering user information corresponding to the user account will be described with reference to sequence diagrams and diagrams showing screen transition. The procedures and processing steps of the respective programs described below basically indicate processing by the CPU 121 of the terminal 12, the CPU of the label server 22, or the CPU of the management server 26 in accordance with instructions described in the respective programs. The processing by each CPU includes hardware control using the API of the OS. In the present specification, the description of the OS is omitted and the operation of each program will be described. The label server 22 executes the processing in accordance with the label server program 23, and the management server 26 executes the processing in accordance with the management server program 27.

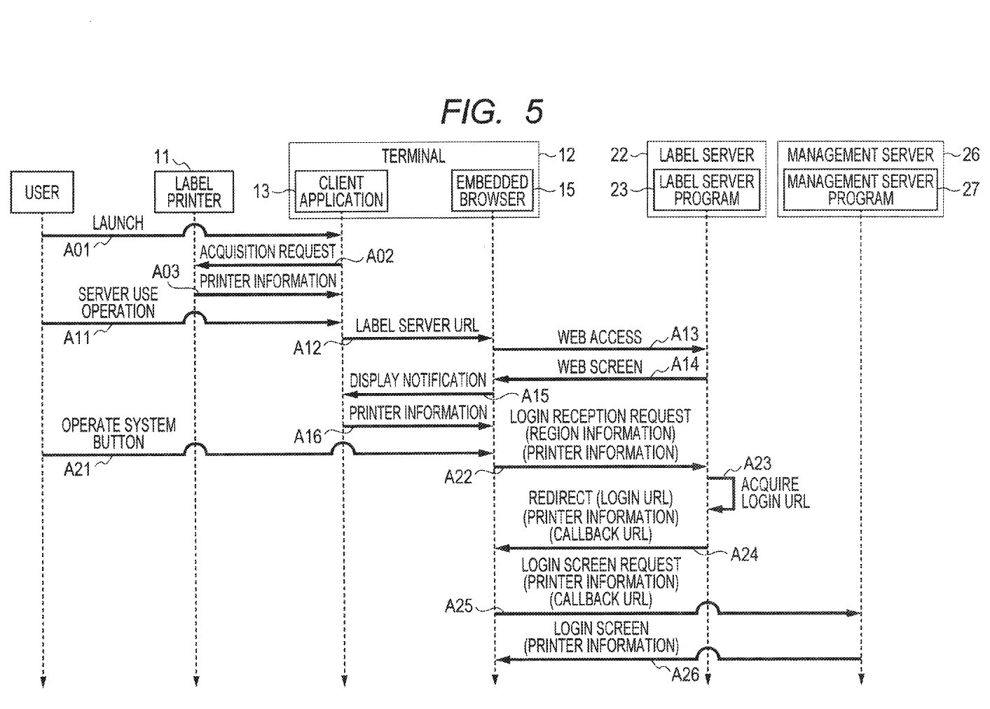

In the system 100 of the present embodiment, as shown in FIG. 5, the user first launches the client application 13 at the terminal 12 (A01). As a process at startup (launch) of the client application 13, the client application 13 accesses the label printer 11 connected to the terminal 12 and requests acquisition of printer information (A02). The label printer 11 responds with its printer information in response to the request (A03). Thus, the client application 13 acquires the printer information from the label printer 11 connected to the terminal 12. Steps A02 and A03 are examples of an acquisition process. The printer information is stored in the label printer 11. The printer information is information to be entered when a new user account is created, which will be described later. The printer information may include the model information or the serial number of the label printer 11, for example.

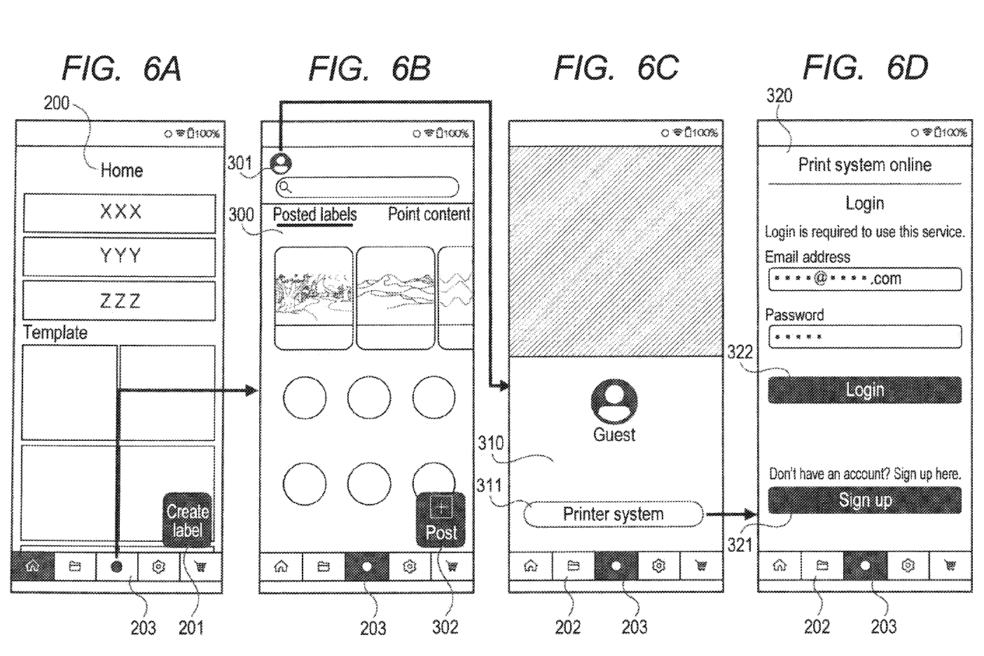

After the client application 13 is launched, as shown in FIG. 6A, the client application 13 causes the user interface 123 to display a home screen 200 and receives various operations from the user. For example, when the client application 13 receives an operation to a label creation button 201, the client application 13 causes the user interface 123 to display an editing screen (not shown) for editing label data. The user edits the label data on the displayed editing screen. When the client application 13 receives an operation for storing label data that is being edited on the editing screen, the client application 13 stores the label data that is being edited in the memory 122, and when the client application 13 receives an operation for printing, the client application 13 transfers print data based on the label data that is being edited to the label printer 11 and prints a label indicated by the label data by the label printer 11. When the client application 13 receives, for example, an operation of selecting one of the label data 14 stored in the memory 122, the client application 13 reads the selected label data 14 and displays the editing screen for editing the read label data 14 on the user interface 123.

The client application 13 is configured to receive an operation to a server use button (server access button) 203 from among menu icons displayed at the lower part of the screen. When the user operates the server use button 203 via the user interface 123 (A11), the client application 13 launches an embedded browser 15 which is a program incorporated in the client application 13, and transfers a URL for accessing the label server 22 to the embedded browser 15 (A12). The embedded browser 15 is a program that operates as a part of the client application 13, and has a function of displaying a screen based on a web page on the screen of the client application 13.

The embedded browser 15 accesses the label server 22 based on the received URL (A13), acquires a web screen 300 from the label server 22 (A14), and causes the user interface 123 to display the acquired web screen 300 as shown in FIG. 6B. The web screen 300 includes a list of label data registered (stored) in the label database 25, a user information button 301 indicating information of the login user, and a posting button 302 for posting label data. The web screen 300 is an example of a screen provided from the server, and the label server 22 is an example of a server.

After acquiring the web screen 300, the embedded browser 15 notifies the client application 13 of the display of the web screen 300 (A15). When the notification is received from the embedded browser 15, the client application 13 transfers the printer information acquired from the label printer 11 in advance to the embedded browser 15 (A16). A16 is an example of a notification process. The embedded browser 15 temporarily stores the received printer information.

In a case where the client application 13 has not acquired the printer information because the client application 13 is not connected to the label printer 11 at startup, the client application 13 may access the label printer 11 to acquire the printer information in response to the notification from the embedded browser 15, and may pass the acquired printer information to the embedded browser 15. When the client application 13 cannot acquire the printer information, the client application 13 transfers information indicating that the printer information is not present to the embedded browser 15. The client application 13 may also pass information held by the client application 13, for example, region information, to the embedded browser 15 together with the printer information.

In response to receiving an operation on the user information button 301, the embedded browser 15 causes the user interface 123 to display a user information screen 310 indicating information of the login user, as shown in FIG. 6C. The user information screen 310 includes user information of the login user registered in the user database 24 and a printer system button 311 for accessing the management server 26. The user information screen 310 shown in FIG. 6C shows a state in which the user has not logged in, and information as a guest user is displayed in the information of the login user. In the case of the logged-in state, the user name 242 and the icon 243 registered (stored) in the user database 24 are displayed on the user information screen 310.

When the user operates the printer system button 311 (A21), the embedded browser 15 transmits a login reception request to the label server 22 (A22). The login reception request to the label server 22 is an example of a first login request. The login reception request is associated with printer information and region information. The region information is a parameter for specifying an authentication server such as JP or US.

In the present system 100, at the time of login for using the label server 22, user authentication by a user account registered in the management server 26 is requested. Therefore, in response to receiving the login reception request from the embedded browser 15 of the terminal 12, the label server program 23 acquires a login URL for accessing the management server 26 based on the region information associated with the login reception request (A23). The label server program 23 stores the login URLs for respective regions, and reads out the login URL suitable for the region information received from the embedded browser 15 of the terminal 12.

Thereafter, the label server program 23 transmits a redirect request to the embedded browser 15 that transmitted the login reception request (A24). The redirect request is associated with the login URL acquired based on the region information, the printer information associated with the login reception request, and a callback URL.

The embedded browser 15, which has received the redirect request, accesses the management server 26 based on the login URL (A25), receives a login screen 320 from the management server 26 (A26), and causes the user interface 123 to display the received login screen 320 as shown in FIG. 6D. The login screen 320 is an example of a login screen provided from another server (second server), and the management server 26 is an example of another server (second server). The request for accessing the management server 26 in A25 is an example of a second login request. When the user accesses the management server 26 based on the login URL, the embedded browser 15 transmits the printer information and the callback URL transmitted from the label server 22 to the management server 26. The embedded browser 15 receives the login screen 320 and the printer information associated with the login screen 320 from the management server 26.

The login screen 320 includes items for entering information for login such as an email address and a password, a login button 322 for instructing login, and a new registration button (sign-up button) 321 for registering a new user account. When the login button 322 is operated, the management server 26 performs user authentication based on the entered information for login. When the new registration button 321 is operated, the processing proceeds to a procedure for creating a new user account.

The procedure for registering a new user account in response to the new registration button 321 will be described below. The authentication for new user account registration is performed according to the OAuth2.0 Authorization Code Flow. The operation of the new registration button 321 is an example of a new creation instruction. The description of the user authentication procedure by the management server 26 in response to the login button 322 will be omitted.

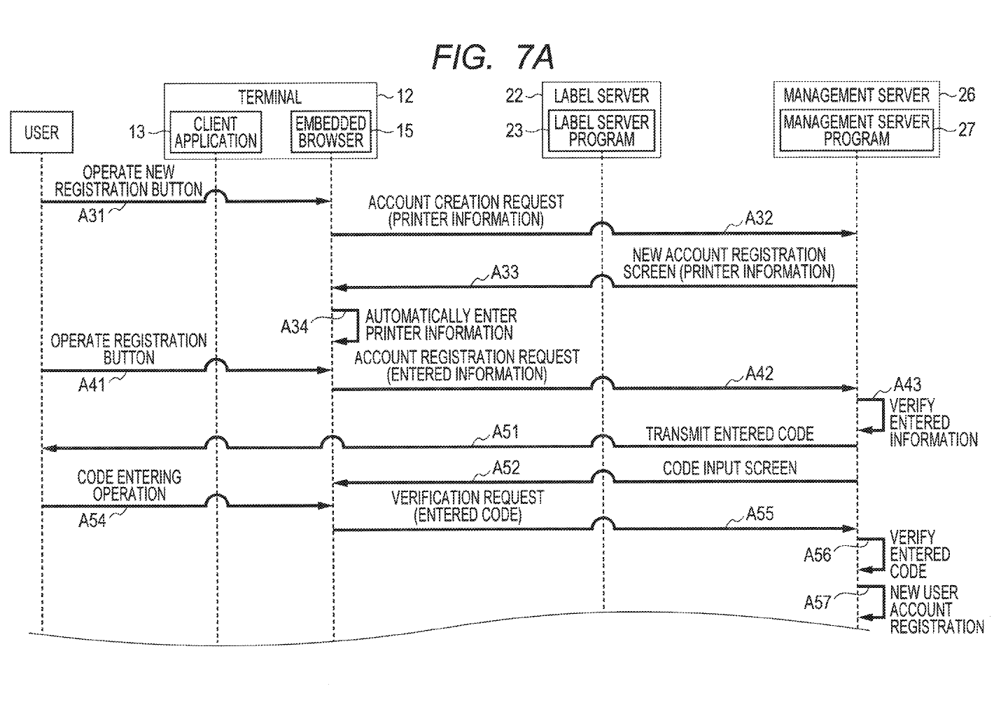

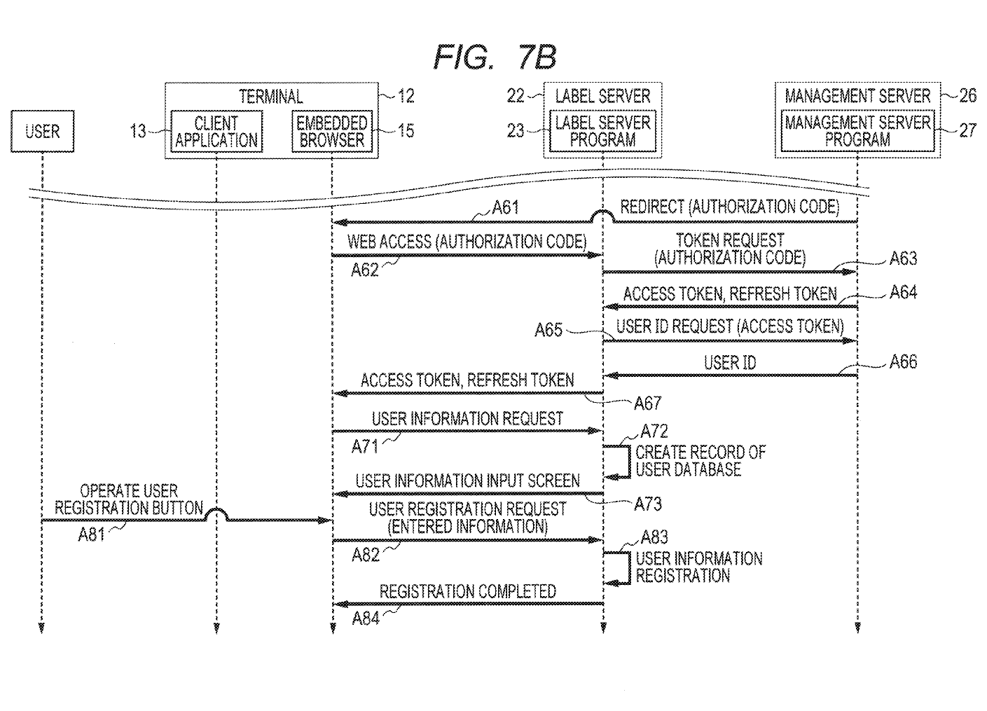

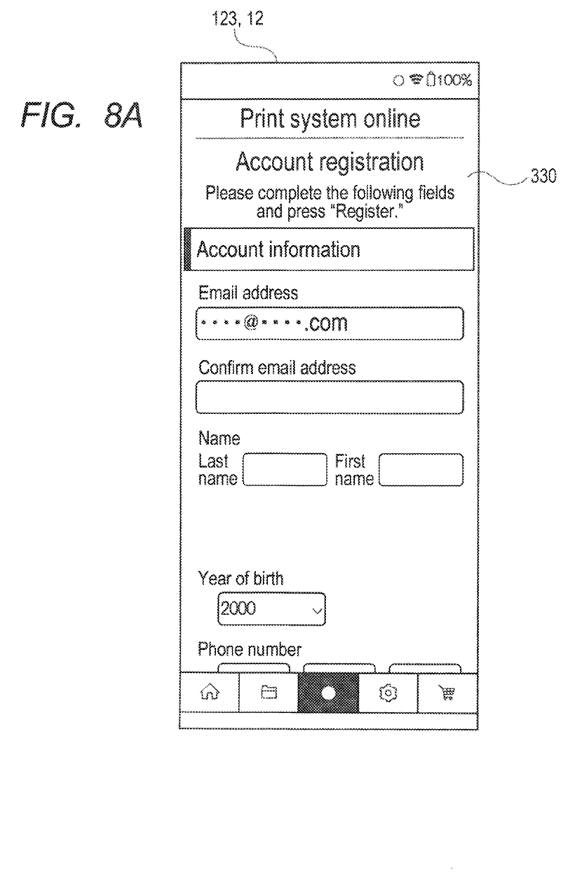

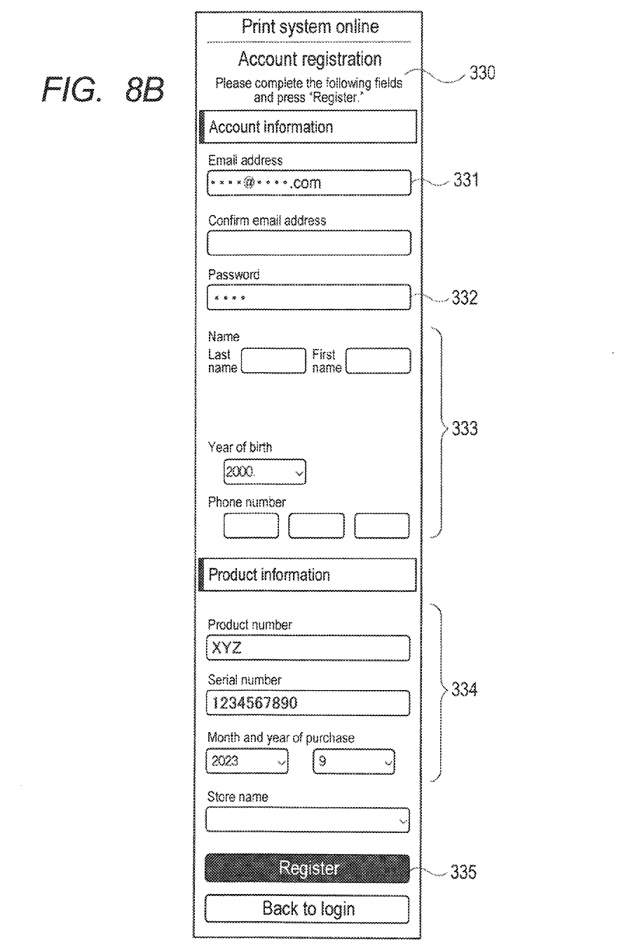

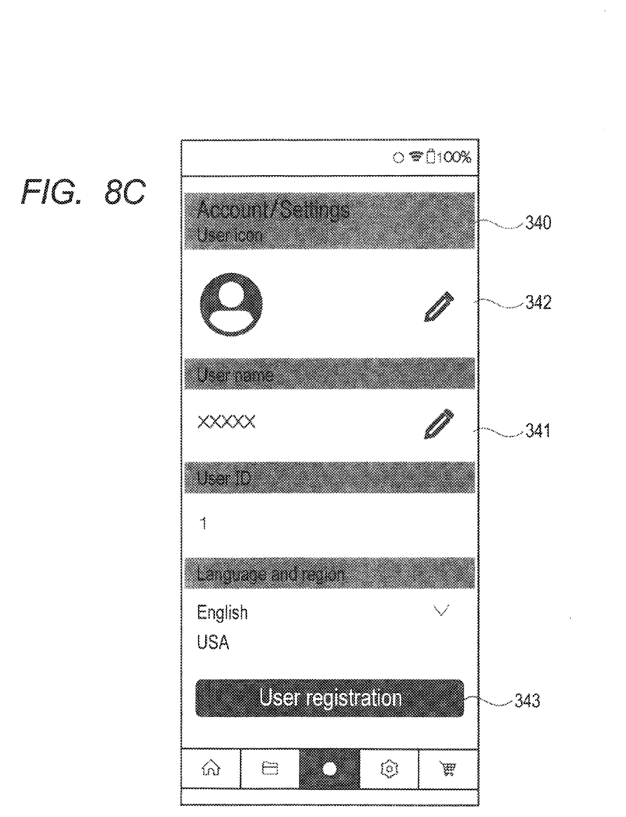

Specifically, as shown in FIG. 7A, when the user operates the new registration button 321 (A31), the embedded browser 15 transmits an account creation request to the management server 26 (A32). The printer information is associated with the account creation request. When the management server 26 receives the account creation request, the management server program 27 transmits a new account registration screen 330 to the embedded browser 15 (A33), and the embedded browser 15 displays the acquired new account registration screen 330 on the user interface 123 as shown in FIGS. 8A and 8B. The new account registration screen 330 has many input items, and it is difficult to display the entire screen on the user interface 123. FIG. 8A shows an example in which the new account registration screen 330 is displayed on the user interface 123, and a part of the new account registration screen 330 is displayed on the user interface 123, and the entire screen is displayed by scrolling the screen. FIG. 8B shows the entire new account registration screen 330 including a portion not displayed on the user interface 123. The new account registration screen 330 is an example of an account creation screen. The embedded browser 15 receives, from the management server 26, the new account registration screen 330 and the printer information associated with the new account registration screen 330.

The new account registration screen 330 includes input fields for entering various information for creating an account such as an email address 331, a password 332, personal information 333, product information 334, and so on, and also includes a registration button 335 for instructing new registration of a user account. The product information 334 is an example of an input field for receiving printer information. At the time of displaying the new account registration screen 330 in A34, the embedded browser 15 automatically enters the model name and the serial number included in the printer information received from the management server 26 (that is, the printer information that is transferred from the client application 13 when the web screen 300 is displayed at startup, and that is received again via the label server 22 and the management server 26) into the input fields of the model name and the serial number of the product information 334 (A34). That is, the input field of the new account registration screen 330 (account creation screen) is filled with the printer information acquired from the printer 11 as an initial value of the printer information. In other words, the input field of the new account registration screen 330 (account creation screen) is in a state where the acquired printer information is entered as the initial value. A34 is an example of an entering process. For example, in a case where the model name is "XYZ" and the serial number is "1234567890", "XYZ" is entered in the field of the product model number and "1234567890" is entered in the field of the serial number in the product information 334 shown in FIG. 8B. Although the model name and the serial number are automatically entered, a manual change by the user is received. In a case where the printer information is not provided from the client application 13, the product model number and the serial number of the product information 334 are displayed in a blank state, and a manual input by the user is received.

Returning to the description of FIG. 7A, the user performs an input operation for the item whose input is requested on the new account registration screen 330. When the user operates the registration button 335 (A41), the embedded browser 15 transmits an account registration request to the management server 26 (A42). The account registration request is an example of a registration request, and A42 is an example of a registration request process. The account registration request is associated with information entered in the new account registration screen 330, that is, information of the email address 331, the password 332, the personal information 333, and the product information 334.

When the management server 26 receives the account registration request, the management server program 27 verifies various information that have been entered (A43). The management server program 27 verifies whether all items have been entered, and whether the entered email address is not the same as an existing email address. When the entered information is incomplete, the management server program 27 responds to the embedded browser 15 to indicate that the entered information is incomplete, and requests the user to enter the information again on the new account registration screen 330.

When the entered information is found to be correct, the management server program 27 transmits an authentication code to the entered email address (A51), and transmits a code input screen for entering the authentication code to the embedded browser 15 (A52), and the embedded browser 15 causes the user interface 123 to display the received code input screen. When the user enters the authentication code (A54), the embedded browser 15 transmits a verification request of the authentication code (A55). The verification request is associated with the entered authentication code.

When the management server 26 receives the verification request for the authentication code, the management server program 27 verifies the entered authentication code (A56). The management server program 27 verifies whether the authentication code transmitted to the email address matches the entered authentication code. When the entered authentication code does not match the transmitted authentication code, the management server program 27 responds to the embedded browser 15 that the entered authentication code is incorrect, and requests the user to enter the code again on the code input screen.

When the entered authentication code matches the transmitted authentication code, the management server program 27 creates a new user account and registers (stores) the new user account in the account database 28 (A57). In this embodiment, a new record having a new user ID is created in the account database 28 as a record corresponding to the new user account, and various information entered in the new account registration screen 330 is written in the record. Thus, the user account for using the system 100 is registered.

After the new user account is registered, a procedure for transmitting an access token from the management server 26 to the embedded browser 15 is performed. That is, as shown in FIG. 7B, the management server 26 transmits a redirect request to the embedded browser 15 that transmitted the account registration request (A61). An authorization code is associated with the redirect request. The embedded browser 15 that has received the redirect request accesses the label server 22 and transmits the authorization code (A62). The label server program 23 transmits, to the management server 26, a token request and the authorization code associated with the token request (A63). When the management server 26 receives the authorization code from the label server 22, the management server program 27 transmits an access token and a refresh token to the label server 22 (A64).

The label server program 23 requests the management server 26 to acquire an ID for identifying the user account by using the received access token (A65), and acquires the user ID of the newly registered user account from the management server 26 (A66). In a case where the email address also serves as the user ID, the email address is acquired. Then, the label server 22 transmits the access token and the refresh token to the embedded browser 15 (A67).

In response to receiving the access token and the refresh token from the label server 22, the embedded browser 15 transmits, to the label server 22, a request for acquisition of user information managed by the label server 22 (A71). When the label server 22 receives the request for acquisition of user information, the label server program 23 creates a record corresponding to the new user account registered in the management server 26 in the user database 24, and writes the user ID received from the management server 26 in the user ID of the record corresponding to the user account (A72). The label server program 23 transmits a user information input screen 340 to the embedded browser 15 (A73), where the user information input screen 340 is associated with the ID of the user account.

As shown in FIG. 8C, the embedded browser 15 causes the user interface 123 to display the received user information input screen 340. The user information input screen 340 includes a user ID received from the management server 26, a user name 341 and an icon 342 as input items, and a user registration button 343. In a case where the email address also serves as the user ID, the email address is displayed instead of the user ID.

The user performs an input operation on the user information input screen 340 for the items for which input is requested. When the user operates the user registration button 343 in a state where all the items are entered (A81), the embedded browser 15 transmits a user registration request to the label server 22 (A82). The user registration request is associated with information entered in the user information input screen 340, that is, information of the user name 341 and the icon 342.

When the label server 22 receives the user registration request, the label server program 23 registers the user information corresponding to the new user account in the user database 24 (A83). That is, various information entered in the user information input screen 340 is written in the record corresponding to the new user account. Thus, the user information for using the label server 22 is registered. After the registration of the user information, the label server program 23 notifies the embedded browser 15 of the completion of the registration (A84), and the procedure for registering the new user account ends.

Thereafter, the user uses the services provided by the label server 22. When the user logs out and logs in again, the user logs in by entering the email address and password of the registered user account and operating the login button 322 on the login screen 320 shown in FIG. 6D, and the services provided by the label server 22 are usable when the login is successful.

Next, a procedure for posting the label data 14 at the terminal 12 included in the system 100 will be described with reference to a diagram showing screen transition and a sequence diagram. In the following description, the process of the embedded browser 15 is omitted regarding the communication between the client application 13 and the label server program 23, but in practice, the web screens provided from the label server 22 are displayed and data is transmitted and received between the client application 13 and the label server program 23 via the embedded browser 15 that is launched by the client application 13. Here, it is assumed that the client application 13 is in a state where user authentication using the user account created in the above description is performed, that is, a state where the user of the user account is logged in.

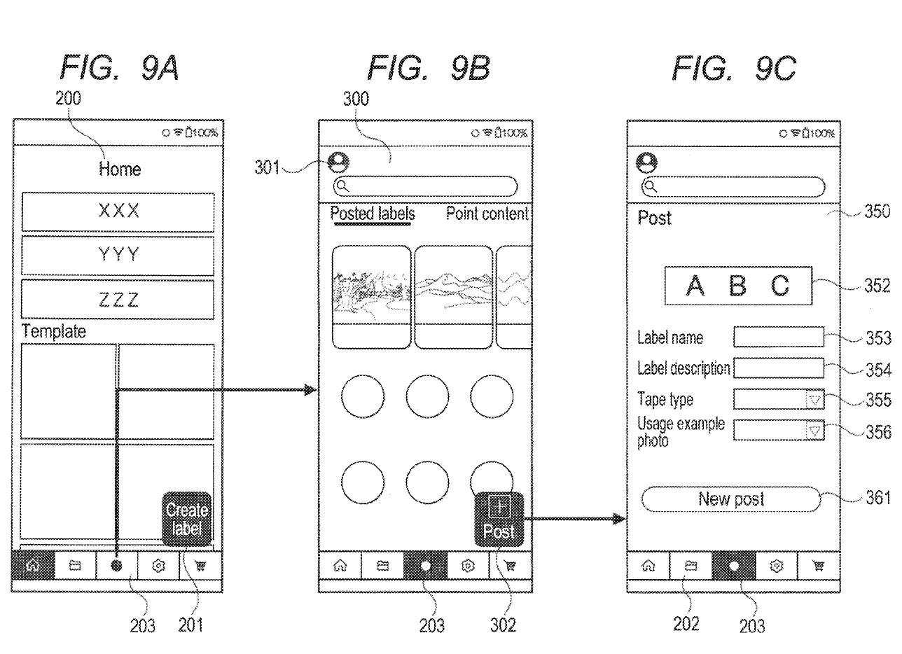

For example, in response to receiving an operation of the server use button 203 displayed on the home screen 200 shown in FIG. 9A via the user interface 123, the client application 13 connects to the label server 22 and causes the user interface 123 to display the web screen 300 shown in FIG. 9B. The web screen 300 allows the user to search for label data registered (stored) in the label database 25. The web screen 300 displays label data registered (stored) in the label database 25 and the posting button 302.

In response to receiving a posting screen display instruction by an operation on the posting button 302, the client application 13 displays a stored label list screen (not shown) for displaying a selectable list of label data stored in the terminal 12. The client application 13 receives an operation of selecting one label data to be uploaded from one or more label data displayed in the list.

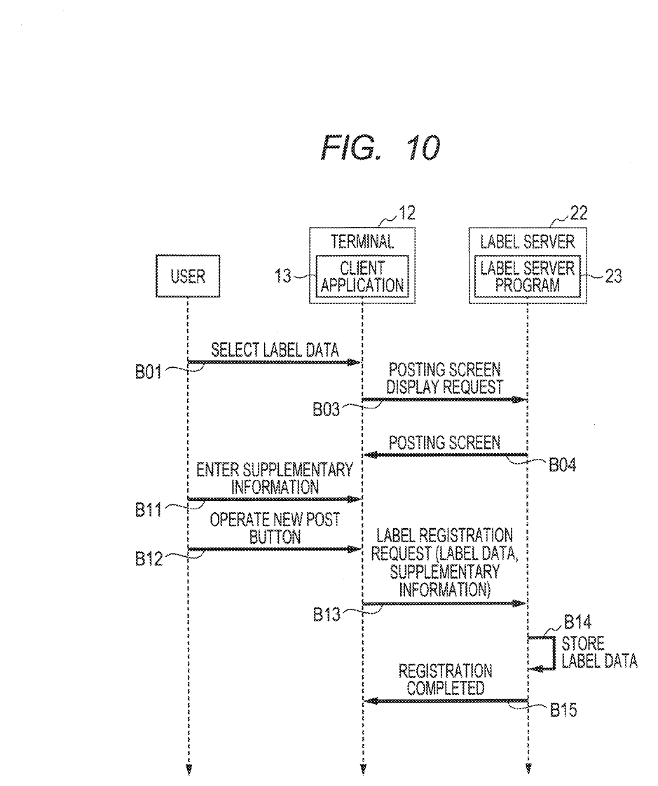

As shown in FIG. 10, when the user selects label data to be uploaded (B01), the client application 13 requests the label server 22 to display a posting screen (B03). In response to the request, the label server program 23 transmits a posting screen 350 shown in FIG. 9C to the client application 13 (B04), and the client application 13 causes the user interface 123 to display the posting screen 350. In a case where the user has not logged in, before B03, the label server program 23 causes the client application 13 to display the login screen 320 provided from the management server 26 by the redirect request, and requests the user of the client application 13 to perform an operation for logging in, and the client application 13 moves to B03 on the condition that the login state is established.

The client application 13 is configured to receive supplementary information via the posting screen 350 for the label data 14 selected as the upload target. For example, a label name input field 353, a label description input field 354, a tape type setting field 355, a usage example photo image setting field 356, and a new posting button 361 are displayed on the posting screen 350. The posting screen 350 may display an image 352 of the label indicated by the label data 14 selected in B01. The client application 13 receives the entered label name and so on as supplementary information of the label data 14 selected in B01 when a label name indicating the name of the label data 14, a description of the label, a tape model number suitable for printing the label, and a photographic image indicating the usage example of the label are entered into the label name input field 353, the label description input field 354, the tape type setting field 355, and the usage example photo image setting field 356, respectively (B11). The supplemental information is displayed, for example, on the web screen 300 to assist the user in selecting label data to be downloaded. The supplementary information is not limited to the examples in this embodiment.

When the user operates the new posting button 361 of the posting screen 350 (B12), the client application 13 transmits a label registration request for registering label data to the label server 22 (B13). The label data selected in B01 and the supplementary information input in B11 are associated with the label registration request.

The label server program 23 stores the label data associated with the received label registration request in the label database 25 (B14). Specifically, the label server program 23 creates a new label ID, and registers (stores) a record in the label database 25. The record includes the label ID, the user ID of the login user, the received label data, and the received supplementary information associated with one another.

When the registration of the posted label data is completed, the label server program 23 notifies the terminal 12 of registration completion (B15). The client application 13 causes the terminal 12 to display a message indicating that the registration of the posted label data is completed. This allows the user to know that the posting is completed.

The terminal 12 may also download label data registered (stored) in the label database 25 via the client application 13. That is, by selecting label data to be downloaded on the web screen 300 shown in FIG. 9B and sending a download instruction to the label server 22, the selected label data 14 is downloaded to the terminal 12. In this way, sharing of the label data is achieved by the system 100.

As described in detail above, according to the client application 13 of the present embodiment, the client application 13 acquires the printer information from the label printer 11 in advance, transfers the printer information to the embedded browser 15 launched by the client application 13, and automatically enters the printer information by the embedded browser 15 when creating a new user account, thereby eliminating the user operation for entering the printer information. This allows the user to reduce the trouble of creating the user account.

The printer information includes complex codes. Further, the printer information is often described in a manual or on the back surface of the printer main body, and the location of the printer information may not be easily known to the user. Therefore, it is troublesome for the user to manually enter the printer information, and this may cause the user to give up the use of the services provided by the system 100. Since the client application 13 reduces the trouble of entering the printer information as in the present embodiment, such a barrier in using the service is eliminated, and as a result, the use of the services provided by the system 100 is promoted.

In the embodiment, the printer information is transmitted and received between the terminal 12 and the label server 22 or the management server 26 as shown in FIGS. 5 and 7A. This allows the label server 22 and the management server 26 to change operations by referring to the printer information. For example, the services provided by the label server 22 and the management server 26 are changed (optimized) depending on the model of the printer. Further, since the client application 13 and the embedded browser 15 do not store and manage the printer information, the client application 13 and the embedded browser 15 are simplified.

While the present disclosure has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the disclosure, and not limiting the disclosure. Various changes may be made without departing from the spirit and scope of the disclosure. Thus, the disclosure is intended to embrace all known or later developed alternatives, modifications, variations, improvements, and/or substantial equivalents. Some specific examples of potential alternatives, modifications, or variations in the described disclosure are provided below.

For example, the printing method of the label printer 11 is not limited to the thermal transfer method, and may be, for example, an inkjet method, an electrophotographic method, or a thermal method. The print medium is not limited to the label sheet, and may be, for example, plain roll paper, fanfold paper, or cut paper. The screens shown in the drawings are examples, and the wording, the arrangement of information, the shape of buttons, and so on in the drawings are not limited to those shown in the drawings.

In the embodiment, a server (the management server 26) for managing user accounts and a server (the label server 22) for managing label data are separately provided, and user accounts usable for other services are created. Alternatively, user accounts may be created exclusively for the server for managing label data. In this case, a redirect request for transferring from the server that has received the login reception request from the client application 13 to another server is not used. For example, the label server 22 may provide a screen for creating a user account (the login screen 320 and the new account registration screen 330 in the embodiment), automatically enter printer information to be entered on the screen, and create and register a user account based on the entered information. In this case, the information registered in the user account (the information registered in the account database 28 in the embodiment) and the information registered in the user database 24 may be integrated and registered (stored) in one database.

In the embodiment, the present disclosure is applied to a user account used in a system that shares label data, but the present disclosure is not limited to a system that shares label data. For example, the system may share image data or document data, and in this case, the printer is not limited to a label printer, but may be a general printer.

In the embodiment, the embedded browser 15 immediately transmits the printer information received from the client application 13 to the label server 22, and then transmits and receives the printer information to and from the label server 22 or the management server 26 each time the embedded browser 15 communicates with the label server 22 or the management server 26, and finally automatically enters the printer information received from the management server 26 into the new account registration screen 330. Alternatively, the embedded browser 15 may continue to store the printer information in a separate storage area, and may read out that printer information when automatically entering the printer information into the new account registration screen 330.

In the flowcharts disclosed in the embodiment, the execution order of the plural processes in the plural steps may be changed or the processes may be executed in parallel as long as the steps do not contradict each other.

The processes disclosed in the embodiment may be performed by a single CPU, a plurality of CPUs, hardware such as an ASIC, or a combination of these elements. The processing disclosed in the embodiment may be realized by various modes such as a storage medium storing a program for executing the processes or a method of executing the processes.

What is claimed is:

1. A non-transitory computer-readable storage medium storing a set of program instructions for an information processing apparatus comprising a controller and a communication interface, the information processing apparatus configured to communicate with a first server via the communication interface, the set of program instructions, when executed by the controller, causing the information processing apparatus to perform:
acquiring printer information from a printer connected to the information processing apparatus;
in response to receiving an access instruction to the first server, controlling a display to display a particular screen provided from the first server, and after displaying the particular screen, receiving a creation instruction of creating a user account; and
in response to receiving the creation instruction, controlling the display to display an account creation screen for receiving input of registration information used for creating the user account,
wherein the account creation screen includes an input field for receiving printer information; and
wherein the input field of the account creation screen is filled with the acquired printer information as an initial value of the printer information.

2. The non-transitory computer-readable storage medium according to claim 1, wherein the set of program instructions, when executed by the controller, causes the information processing apparatus to perform:
in response to receiving a login instruction via the particular screen, displaying a login screen provided from a second server different from the first server, the creation instruction being received via the login screen;
in response to receiving the creation instruction, displaying the account creation screen provided from the second server, a new registration instruction of the user account received via the account creation screen;
in response to receiving the new registration instruction, transmitting registration information entered in the account creation screen to the second server, the registration information including the printer information entered into the input field as the initial value, the second server having received the registration information configured to create the user account and register the user account;
after the user account is registered in the second server, waiting to receive input of user information and a registration instruction; and
in response to receiving the registration instruction, transmitting, to the first server, a registration request and the user information associated with the registration request, the first server having received the registration request configured to register the user information associated with the user account registered at the second server.

3. The non-transitory computer-readable storage medium according to claim 1, wherein the set of program instructions, when executed by the controller, causes the information processing apparatus to perform:
in response to receiving a request requesting access to the first server, launching an embedded browser functioning as a web browser, and displaying the particular screen by the embedded browser; and
in response to receiving the creation instruction via the particular screen, displaying the account creation screen by the embedded browser and entering the printer information into the input field of the account creation screen as the initial value by the embedded browser.

4. The non-transitory computer-readable storage medium according to claim 3, wherein the set of program instructions, when executed by the controller, causes the information processing apparatus to perform:
in response to receiving a login instruction via the particular screen, displaying, by the embedded browser, a login screen provided from a second server different from the first server, the creation instruction being received via the login screen;
in response to receiving the creation instruction, displaying, by the embedded browser, the account creation screen provided from the second server, a new registration instruction of the user account being received via the account creation screen;
in response to receiving the new registration instruction, transmitting, by the embedded browser, registration information entered in the account creation screen to the second server, the registration information including the printer information entered into the input field as the initial value, the second server having received the registration information configured to create the user account and register the user account;
after the user account is registered in the second server, receiving, by the embedded browser, input of user information and a registration instruction; and
in response to receiving the registration instruction, transmitting, by the embedded browser, a registration request and the user information associated with the registration request to the first server, the first server having received the registration request configured to register the user information associated with the user account registered at the second server.

5. The non-transitory computer-readable storage medium according to claim 4, wherein the set of program instructions, when executed by the controller, causes the information processing apparatus to perform:
in response to receiving the login instruction, transmitting, by the embedded browser, a first login request to the first server;
in response to receiving a redirect request from the first server in response to the first login request, transmitting, by the embedded browser, a second login request to the second server; and
displaying the login screen provided from the second server in response to the second login request.

6. The non-transitory computer-readable storage medium according to claim 5, wherein the set of program instructions, when executed by the controller, causes the information processing apparatus to perform:
in response to receiving the login instruction, transmitting, by the embedded browser, the first login request and the printer information associated with the first login request to the first server;
after transmitting the first login request, waiting to receive, by the embedded browser, the redirect request and the printer information associated with the redirect request from the first server, the printer information being associated with the first login request;
in response to receiving the redirect request and the printer information, transmitting, by the embedded browser, the second login request and the printer information associated with the second login request to the second server, the printer information being associated with the redirect request;
in response to receiving the second login request, displaying a login screen provided from the second server, the login screen being associated with the printer information transmitted with the second login request;
in response to receiving the creation instruction, transmitting, by the embedded browser, an account creation screen request and the printer information associated with the account creation screen request to the second server, the printer information being associated with the login screen;
after transmitting the account creation screen request, receiving, by the embedded browser, the account creation screen and the printer information associated with the account creation screen, the printer information being associated with the account creation screen request;
in response to receiving the account creation screen and the printer information, displaying the account creation screen by the embedded browser; and
wherein, when displaying the account creation screen, the printer information associated with the account creation screen is filled into the input field of the account creation screen as the initial value.

7. The non-transitory computer-readable storage medium according to claim 1, wherein the set of program instructions, when executed by the controller, causes the information processing apparatus to perform:
acquiring the printer information from the printer at startup of a program including the set of program instructions.

8. The non-transitory computer-readable storage medium according to claim 1, wherein the set of program instructions, when executed by the controller, causes the information processing apparatus to perform:
acquiring the printer information from a label printer, the label printer being the printer connected to the information processing apparatus; and
entering the acquired printer information of the label printer into the input field of the account creation screen.

9. The non-transitory computer-readable storage medium according to claim 8, wherein the set of program instructions, when executed by the controller, causes the information processing apparatus to perform:
waiting to receive, via the account creation screen, a registration instruction of the user account including the printer information;
in response to receiving the registration information, waiting to receive a new registration instruction; and
in response to receiving the new registration instruction, transmitting a user registration request to the first server, the first server configured to register the user account in response to receiving the user registration request.

10. The non-transitory computer-readable storage medium according to claim 1, wherein the printer information includes model information or a serial number of the printer.

11. An information processing apparatus comprising:
a communication interface configured to communicate with a server; and
a controller configured to perform:
acquiring printer information from a printer connected to the information processing apparatus;
in response to receiving an access instruction to the server, controlling a display to display a particular screen provided from the server, and after displaying the particular screen, receiving a creation instruction of creating a user account;
in response to receiving the creation instruction, controlling the display to display an account creation screen for receiving input of registration information used for creating the user account, the account creation screen including an input field that receives printer information; and
when displaying the account creation screen, the input field of the account creation screen is in a state where the acquired printer information is entered as an initial value.

12. A system comprising a terminal connected to a printer, a label server, and a management server configured to communicate with one another via a network,
the terminal configured to perform:
acquiring printer information from the printer;
in response to receiving an access instruction to the label server, transmitting an access request to the label server;
the label server configured to perform:
in response to receiving the access request, transmitting a particular screen to the terminal;
the terminal configured to perform:
in response to receiving the particular screen provided from the label server, controlling a display to display the particular screen, and after displaying the particular screen, waiting to receive a creation instruction of creating a user account;
in response to receiving the creation instruction, controlling the display to display an account creation screen for receiving input of registration information used for creating the user account, the account creation screen including an input field that receives printer information; and
when displaying the account creation screen, the input field of the account creation screen is in a state where the acquired printer information is entered as an initial value.

13. The system according to claim 12, wherein the terminal is configured to perform:
in response to receiving a login instruction while displaying the particular screen, displaying a login screen provided from the management server;
in response to receiving the creation instruction, displaying the account creation screen provided from the second server, and waiting to receive a new registration instruction of the user account via the account creation screen;
in response to receiving the new registration instruction, transmitting registration information entered in the account creation screen to the management server, the registration information including the printer information entered into the input field of the account creation screen;
the management server configured to perform:
in response to receiving the registration information, creating the user account and registering the user account;
the terminal configured to perform:
after the user account is registered in the management server, waiting to receive input of user information and a registration instruction;
in response to receiving the registration instruction, transmitting, to the label server, a registration request and the user information associated with the registration request; and
the label server configured to perform:
in response to receiving the registration request, registering the user information associated with the user account registered at the management server.

14. The system according to claim 12, wherein the terminal is configured to perform:
in response to receiving a request requesting access to the label server, launching an embedded browser functioning as a web browser, and displaying the particular screen by the embedded browser;
in response to displaying the particular screen by the embedded browser, transferring the printer information to the embedded browser;
after displaying the particular screen, receiving the creation instruction via the embedded browser; and
in response to receiving the creation instruction, displaying the account creation screen by the embedded browser and entering the printer information into the input field of the account creation screen by the embedded browser.

15. The system according to claim 14, wherein the terminal is configured to perform:
in response to receiving a login instruction while displaying the particular screen by the embedded browser, displaying, by the embedded browser, a login screen provided from the management server;
waiting to receive the creation instruction being received via the login screen;
in response to receiving the creation instruction, displaying, by the embedded browser, the account creation screen provided from the management server;
waiting to receive a new registration instruction of the user account via the account creation screen;
in response to receiving the new registration instruction, transmitting, by the embedded browser, registration information entered in the account creation screen to the management server, the registration information including the printer information entered into the input field as the initial value;
the management server configured to perform:
in response to receiving the registration information, creating the user account and registering the user account;
the terminal configured to perform:
after the user account is registered in the management server, receiving, by the embedded browser, input of user information and a registration instruction;
in response to receiving the registration instruction, transmitting, by the embedded browser, a registration request and the user information associated with the registration request to the label server; and
the label server configured to perform:
in response to receiving the registration request, registering the user information associated with the user account registered at the management server.

16. The system according to claim 15, wherein the terminal is configured to perform:
in response to receiving the login instruction, transmitting, by the embedded browser, a first login request to the label server;
in response to receiving a redirect request from the label server in response to the first login request, transmitting, by the embedded browser, a second login request to the management server; and
displaying the login screen provided from the management server in response to the second login request.

17. The system according to claim 16, wherein the terminal is configured to perform:
in response to receiving the login instruction, transmitting, by the embedded browser, the first login request and the printer information associated with the first login request to the label server;
receiving, by the embedded browser, the redirect request and the printer information associated with the redirect request from the label server in response to the first login request, the printer information being associated with the first login request;
in response to receiving the redirect request and the printer information, transmitting, by the embedded browser, the second login request and the printer information associated with the second login request to the management server, the printer information being associated with the redirect request;
displaying a login screen provided from the management server in response to the second login request, the login screen being associated with the printer information transmitted with the second login request;
in response to receiving the creation instruction, transmitting, by the embedded browser, an account creation screen request and the printer information associated with the account creation screen request to the management server, the printer information being associated with the login screen;
receiving, by the embedded browser, the account creation screen and the printer information associated with the account creation screen in response to the account creation screen request, the printer information being associated with the account creation screen request;
in response to receiving the account creation screen and the printer information, displaying the account creation screen by the embedded browser; and
when displaying the account creation screen, the printer information associated with the account creation screen is entered into the input field of the account creation screen as the initial value.

18. The system according to claim 12, wherein the terminal is configured to perform:
acquiring the printer information from a label printer, the label printer being the printer connected to the terminal; and
entering the acquired printer information of the label printer into the input field of the account creation screen.

19. The system according to claim 18, wherein the terminal is configured to perform:
waiting to receive, via the account creation screen, a registration instruction of the user account;
in response to receiving the registration information including the printer information, receiving a new registration instruction;
in response to receiving the new registration instruction, transmitting a user registration request to the label server;
the label server configured to perform:
registering the user account in response to receiving the user registration request;
the terminal configured to perform:
editing a label data;
storing the label data in a memory of the terminal, the label data being printable by the label printer;
uploading the label data stored in the memory to the label server in a state where a user is logged in to the label server by using the user account registered at the label server; and
the label server configured to perform:
storing the uploaded label data associated with the user account of the user.
